(19) United States
(12) Patent Application Publication
(10) Pub. No.: US 2005/0227560 A1
(43) Pub. Date: Oct. 13, 2005

(54) Flexible carbon-fiber laminates

(76) Inventor: Jimmie B. Allred III, Auburn, NY (US)

Correspondence Address: BROWN & MICHAELS, PC;400 M & T BANK BUILDING, 118 NORTH TIOGA ST, ITHACA, NY, 14850, US

(21) Appl. No.: 11/091,991

(22) Filed: Mar. 29, 2005

Related U.S. Application Data
(60) Provisional application No. 60/557,185, filed on Mar. 29, 2004.

(51) Int. Cl. B32B 27/38; B32B 17/02; B32B 5/02

(52) U.S. Cl. 442/172; 442/239; 442/243; 442/301; 442/175; 442/179; 156/285

(57) ABSTRACT

A flexible carbon-fiber laminate material comprising a layer of carbon-fiber and resin material adhered to a layer of thermoplastic or polymer fiber material, creating a flexible carbon-fiber laminate material. A method of making the flexible carbon-fiber laminate material, by wetting the carbon fiber and cloth layers, laying the fiber layer against glass, applying a release layer and breather layer to the back of the cloth layer, encasing all the layers in an airtight bag, evacuating the bag, then removing the bag, the glass and the release and breather layers.

### REFERENCE TO RELATED APPLICATIONS

This application claims an invention which was disclosed in Provisional Application No. 60/557,185, filed Mar. 29, 2004, entitled “Carbon-Fiber Laminates, Methods of Making Carbon-Fiber Laminates, and Products Made of Carbon-Fiber Laminates”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of carbon-fiber laminates. More particularly, the invention pertains to such laminates made of layers of carbon-fiber and resin with a base layer of specific material, methods of making such laminates, and products made with such laminates.

### SUMMARY OF THE INVENTION

The invention comprises a flexible carbon-fiber laminate material comprising a layer of carbon-fiber and resin material adhered to a layer of thermoplastic or polymer fiber material, creating a flexible carbon-fiber laminate material.

The invention also comprises methods of making the carbon-fiber laminate material listed above.

### BRIEF DESCRIPTION OF THE DRAWING

FIGS. 1 and 2 shows a sheet of a flexible carbon-fiber laminate embodiment of the invention from the front and rear, respectively.

FIG. 3 shows a closeup of the laminate, as enclosed in lines 3 in FIG. 2.

FIG. 4 is a flowchart of the method of the invention.

### DETAILED DESCRIPTION OF THE INVENTION

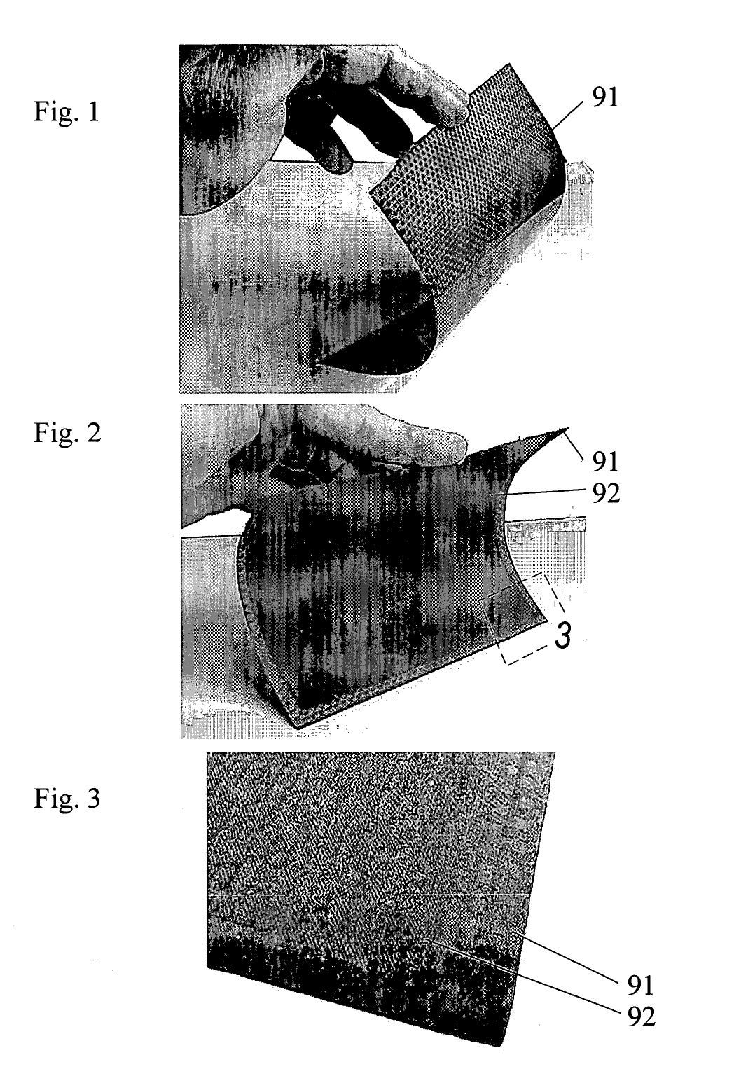

Most carbon-fiber laminate material is quite stiff and rigid. At times, however, a relatively flexible carbon-fiber laminate material is desired. FIGS. 1 and 2 show a sheet of a flexible carbon-fiber laminate embodiment of the invention from the front and rear, respectively. FIG. 3 shows a closeup of the laminate, as enclosed in lines 3 in FIG. 2.

The flexible carbon-fiber laminate material uses a face layer of carbon-fiber material (91). The carbon-fiber material layer (91) is made of one or more layers of carbon fiber in resin matrix. The layer may be made from commercially available pre-impregnated (“prepreg”) sheets—unidirectional or multidirectional carbon fibers in a curable epoxy resin matrix, or from one or more layers of dry carbon fiber fabric or fibers wetted with liquid epoxy.

The carbon fiber material layer (91) is laminated with a base (92) of polyester cloth or other polymer or thermoplastic fiber fabric such as nylon, rayon, or the like, having a lower modulus than the carbon fibers.

The result, as shown in the figures, is a material with the strength of carbon fiber, but the ability to bend around curved surfaces.

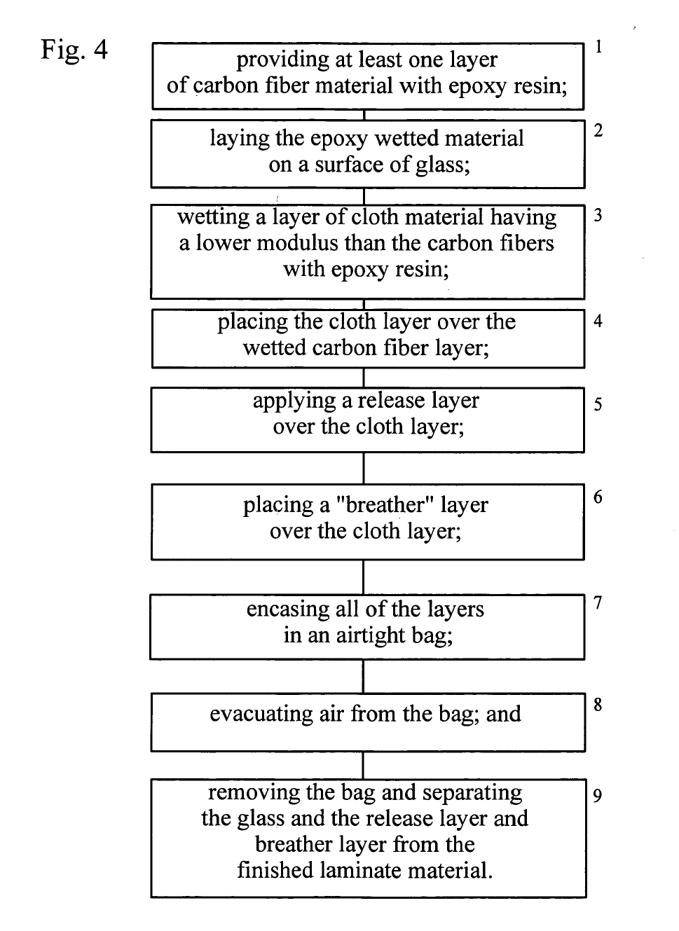

The carbon fiber laminate material of the invention can be made by the following method, as shown in FIG. 4, starting with “dry” carbon fiber material:
1. Wet the carbon fiber material forming the “face” layer (91) with epoxy resin.
2. Lay the epoxy wetted material on a smooth surface, preferably of glass.
3. Wet the cloth material (92) with epoxy resin
4. Place the cloth layer over the wetted carbon fiber face layer (91).
5. Apply a release layer of peel-ply and/or release-ply over the cloth layer.
6. Place a “breather” layer over the cloth layer
7. Encase all of the layers in a plastic bag.
8. Evacuate the air from the bag and cure the epoxy.
9. Remove the bag and separate the glass and the peel-ply, release-ply and breather layers from the finished laminate material.

Alternatively, the method can start with pre-impregnated (“pre-preg”) carbon fiber material, in which case the method would be the same, except that step 1 would not be necessary, since the material would already be impregnated with resin.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A flexible carbon-fiber laminate material comprising at least one layer of carbon fibers in a resin matrix laminated to a layer of cloth having a lower modulus than the carbon fibers.

2. The material of claim 1, in which at least one carbon-fiber layer is made from pre-impregnated sheets of unidirectional or multidirectional carbon fibers in a curable epoxy resin matrix.

3. The material of claim 1, in which at least one carbon-fiber layer is made from one or more layers of dry carbon fiber fabric or fibers wetted with liquid epoxy.

4. The material of claim 1, in which the cloth is a polymer or thermoplastic fiber fabric.

5. The material of claim 4, in which the cloth is polyester.

6. The material of claim 4, in which the cloth is nylon.

7. The material of claim 4, in which the cloth is rayon.

8. A method of making a flexible carbon-fiber laminate material comprising the steps of:
a) providing at least one layer of carbon fiber material with epoxy resin;
b) laying the epoxy wetted material on a smooth surface;
c) wetting a layer of cloth material having a lower modulus than the carbon fibers with epoxy resin;
d) placing the cloth layer over the wetted carbon fiber layer;
e) applying a release layer over the cloth layer;
f) placing a “breather” layer over the cloth layer;
g) encasing all of the layers in an airtight bag;
h) evacuating air from the bag;
i) curing the epoxy; and, after the epoxy is cured,
i) removing the bag and separating the glass and the release layer and breather layer from the finished laminate material.

9. The method of claim 8 in which the release layer is made of peel-ply and/or release-ply material.

10. The method of claim 8, in which the cloth is a polymer or thermoplastic fiber fabric.

11. The method of claim 10, in which the cloth is polyester.

12. The method of claim 10, in which the cloth is nylon.

13. The method of claim 10, in which the cloth is rayon.

14. The method of claim 8, in which step (a) further comprises the step of wetting a layer of carbon fiber with a liquid epoxy resin.

15. The method of claim 8, in which the carbon fiber material provided in step (a) is pre-impregnated sheets of unidirectional or multidirectional carbon fibers in a curable epoxy resin matrix.
